(19) United States
(12) Patent Application Publication
(10) Pub. No.: US 2017/0331382 A1
(43) Pub. Date: Nov. 16, 2017

(54) ELECTRIC POWER CONVERTER

(71) Applicant: FUJI ELECTRIC CO., LTD., Kawasaki-shi (JP)

(72) Inventor: Yoshihisa UEHARA, Hino (JP)

(73) Assignee: FUJI ELECTRIC CO., LTD., Kawasaki-shi (JP)

(21) Appl. No.: 15/478,981

(22) Filed: Apr. 4, 2017

(30) Foreign Application Priority Data
May 13, 2016 (JP) 2016-096705

(51) Int. Cl. H02M 3/335; H02M 1/08; H02M 1/00

(52) U.S. Cl. CPC H02M 3/33507; H02M 1/08; H02M 2001/0054

(57) ABSTRACT

An electric power converter includes an inverter, an insulating transformer, and a rectifier. The inverter converts an input DC voltage, supplied from a DC power supply, to an AC voltage outputted at an AC output side of the inverter, and includes at least one semiconductor switching device made of wide bandgap semiconductor material configured to carry out turning-on and turning-off operations at a specified frequency to thereby invert the DC voltage to the AC voltage at the specified frequency; and at least one freewheeling diode made of silicon-based semiconductor material respectively connected to the at least one switching device in inverse parallel.

### CROSS-REFERENCE TO RELATED APPLICATIONS

This application claims foreign priority to Japanese Patent Application No. 2016-096705, filed May 13, 2016 in the Japanese Patent Office, the content of which is incorporated herein by reference in its entirety.

### BACKGROUND

### 1. Field

The present disclosure relates to an electric power converter which converts a DC voltage to a high-frequency AC voltage by the operation of an inverter, supplies the converted high-frequency AC voltage to a transformer to obtain an AC voltage insulated from the AC voltage on the inverter side before converting thus insulated AC voltage to a DC voltage with a specified magnitude by using a rectifier circuit.

### 2. Related Art

In an electric power converter such as an auxiliary power supply for rolling stock, for downsizing the converter, a technology is actualized by which an AC output voltage of an inverter is changed to a DC voltage with a specified magnitude by using a resonant circuit, a high-frequency insulating transformer and a rectifier circuit to supply the DC voltage to loads such as lighting facilities and air-conditioning facilities.

FIG. 3 is a diagram showing the configuration of an electric power converter of such kind described in JP-A-2013-110786 (paragraphs [0022] to [0049] and FIG. 1, etc.) as an example of a related art.

The electric power converter is provided with a DC power supply 10, an inverter 20 of a half-bridge type including a resonant circuit, a transformer 30 for insulation, a rectifier circuit (rectifying and smoothing circuit) 40 and a control circuit 100 for controlling semiconductor switching devices in the inverter 20 and the rectifier circuit 40. Onto the output side of the rectifier circuit 40, a load 50 is connected.

Here, the inverter 20 is provided with a series circuit with capacitors 21 and 22, a series circuit with semiconductor switching devices 23 and 24 such as IGBTs and the series resonant circuit formed with a capacitor 25 and inductor 26. In addition, the rectifier circuit 40 is provided with a bridge circuit with semiconductor switching devices 41 to 44 each allowing bidirectional current conduction and a capacitor 45 connected onto the output side of the bridge circuit.

In the foregoing configuration according to the related art, the series resonant circuit formed of the capacitor 25 and inductor 26 on the primary winding side of the transformer 30 carries out a high-frequency series resonant operation by alternating turning-on and -off operations between the switching devices 23 and 25, by which a high-frequency AC voltage is outputted from the secondary winding side of the transformer 30. The high-frequency AC voltage is rectified and smoothed by the rectifier circuit 40 to be a DC voltage with a specified magnitude, which is supplied to the load 50. In particular, by making the semiconductor switching devices 41 to 44 in the rectifier circuit 40 selectively turned-on and -off in synchronization with the turning-on and -off of the semiconductor switching devices 23 and 24, the semiconductor switching devices 23, 24 and 41 to 44 are made to carry out switching with zero voltages and zero currents to thereby reduce the switching losses thereof.

In the next, FIG. 4 is a diagram showing the configuration of an electric power converter described in JP-A-2014-233121 (paragraphs [0009] to [0018] and FIG. 1, etc.) as another example of the related art.

In FIG. 4, reference numerals 61, 62 and 63 designate a pantograph, wheels of an electric car and a step-up reactor, respectively. The electric power converter is provided with a step-up chopper 70, a half-bridge inverter 80 and a rectifying and smoothing circuit 90. The step-up chopper 70 is made up of a switching device 71 and a diode 72 and the inverter 80 is made up of a series circuit with capacitors 81 and 82 and a series circuit with switching devices 83 and 84. The rectifying and smoothing circuit 90 is made up of diodes 91 to 94 in a bridge connection, a reactor 95 and a capacitor 96. The other constituents are designated by reference numerals being the same as those shown in FIG. 3.

In the configuration according to the foregoing related art, the DC voltage between the pantograph 61 and the wheels 62 is stepped up by the step-up chopper 70 and the DC voltage after being stepped up is inverted to an AC voltage by the inverter 80 before being supplied to the rectifying and smoothing circuit 90 through the transformer 30 to be converted into a DC voltage with a specified magnitude, which is then supplied to a load.

In JP-A-2014-233121, there is described that a wide bandgap semiconductor device made of material such as SiC (silicon carbide) is used for the switching device 71 in the step-up chopper 70 or for each of the switching devices 83 and 84 in the inverter 80 to thereby allow the loss therein to be reduced. The use of a wide bandgap semiconductor device such as an SBD (Schottky barrier diode) also for a freewheeling diode connected in inverse parallel to each of the switching device 71, 83 and 84 can reduce the reverse recovery loss thereof.

However, the use of wide bandgap semiconductor devices for all of the switching devices and freewheeling diodes forming a system such as an inverter causes an increase in the cost of each chip having the switching devices and diodes formed therein to result in an increase in the price of the whole system.

In addition, in the electric power converter described in JP-A-2013-110786, each of the switching devices 23, 24, and 41 to 44 carries out zero voltage and zero current switching to cause no reverse recovery current to flow in the freewheeling diode, for example, connected in inverse parallel to each of the switching devices 23 and 24. Therefore, the use of wide bandgap semiconductor devices also for the freewheeling diodes results in so-called excessive improvement in quality to cause high cost of the system.

Accordingly, this disclosure provides an electric power converter in which useless cost is reduced to permit a reduction in the price thereof.

### SUMMARY

For achieving the aforementioned benefits, a first aspect of the disclosure is that, in an electric power converter including an inverter in which at least one semiconductor switching device connected to a DC power supply carries out turning-on and -off operations at a specified frequency, thereby inverting a DC voltage supplied from the DC power supply to an AC voltage at the frequency to output the inverted AC voltage, an insulating transformer the primary winding of which is connected to the AC output side of the inverter, a rectifier circuit converting the AC voltage outputted from the secondary winding of the transformer to a DC voltage to supply the converted DC voltage to a load, the semiconductor switching device is made of wide bandgap semiconductor material and a freewheeling diode made of silicon-based semiconductor material is connected to the switching device in inverse parallel thereto.

A second aspect of the disclosure is that, in the electric power converter in the first aspect of the disclosure, the inverter has a configuration in which a series circuit of a first and second ones of the semiconductor switching devices is connected across the DC power supply while being connected in parallel to a series circuit of first and second capacitors and, along with this, a resonant circuit, formed of a series connection of a capacitor and an inductor to carry out a resonant operation with the resonant frequency thereof determined as the specified resonant frequency, and the primary winding of the transformer are connected in series between the connection point of the first and second semiconductor switching devices and the connection point of the first and second capacitors, the first and second semiconductor switching devices being alternately turned-on and -off with a duty ratio of 50% by the resonant frequency of the resonant circuit.

A third aspect of the disclosure is that, in the electric power converter in the first or the second aspect of the disclosure, the semiconductor switching device is an FET made of one of SiC, GaN and diamond as wide bandgap semiconductor material.

In the disclosure, the switching devices in the configuration of the inverter are made of wide bandgap semiconductor material and the freewheeling diodes connected in inverse parallel to their respective switching devices are made of silicon-based semiconductor material.

This reduces losses in the switching devices and, along with this, by making the switching devices alternately turned-on and -off by the resonant frequency of the resonant circuit with a duty ratio of 50%, makes it possible to prevent reverse recovery currents from flowing in the freewheeling diodes. Therefore, by the use of freewheeling diodes made of relatively low-priced silicon-based semiconductor material, the electric power convertor can be made to be less expensive.

### BRIEF DESCRIPTION OF THE DRAWINGS

FIG. 1 is a diagram showing the configuration of the main circuit of the electric power converter according to an embodiment of the disclosure;

FIG. 2 is a diagram showing the operation of the main circuit of the electric power converter according to the embodiment of the disclosure shown in FIG. 1;

FIG. 3 is a diagram showing the configuration of an electric power converter described in JP-A-2013-110786 as an example of a related art; and

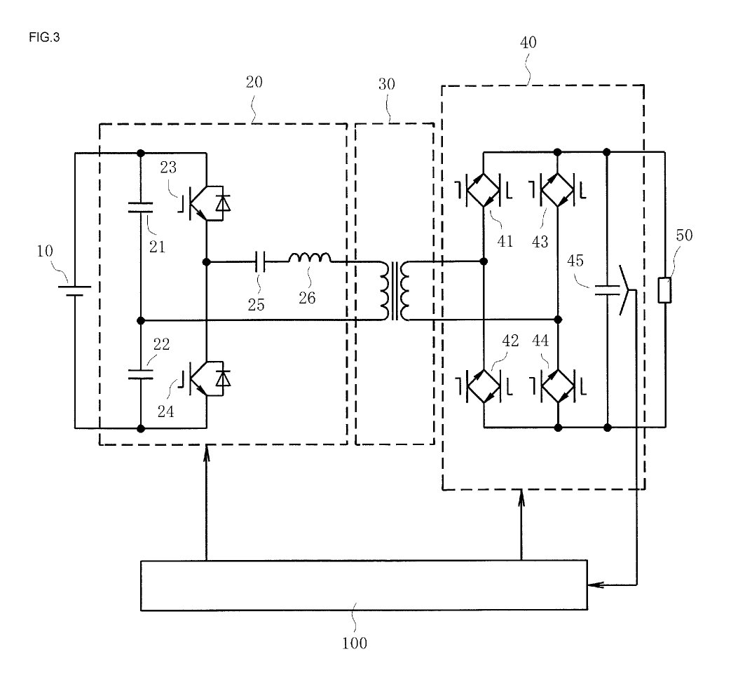

FIG. 4 is a diagram showing the configuration of an electric power converter described in JP-A-2014-233121 as another example of a related art.

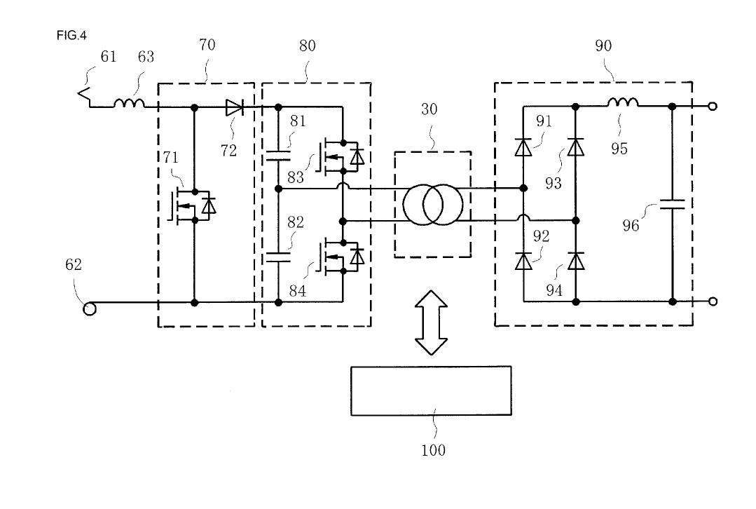

### DESCRIPTION OF EMBODIMENTS

In the following, an embodiment of the disclosure will be explained with reference to the attached drawings.

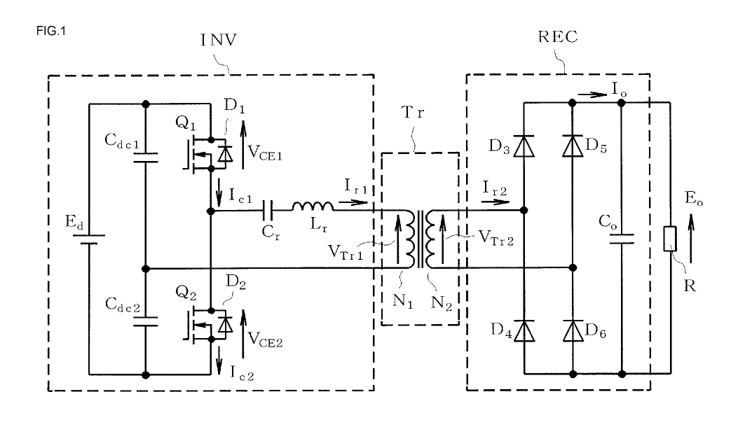

FIG. 1 is a diagram showing the configuration of the main circuit of an electric power converter according to the embodiment of the disclosure. As is shown in the diagram, the electric power converter is provided with an inverter INV, a high-frequency insulating transformer Tr connected to the output side of the inverter INV and a rectifier circuit (rectifier and smoothing circuit) REC and carries out a DC-AC-DC conversion to feed a DC voltage with a specified magnitude to a load R.

The inverter INV is provided with a DC power supply E_{d} (the voltage thereof is also designated as E_{d}), a series circuit of a first capacitor C_{dc1} and a second capacitor C_{dc2} and a series circuit of a first semiconductor switching device Q₁ and a second semiconductor switching device Q₂ both being made of any one of wide bandgap semiconductor materials such as SiC (silicon carbide), GaN (gallium nitride) and diamond. The series circuits are connected in parallel to each other across the DC power supply E_{d}. Here, the switching devices Q₁ and Q₂ are FETs (Field Effect Transistors), for example, to which freewheeling diodes D₁ and D₂ of silicon-based semiconductor material are connected in inverse parallel, respectively.

The capacitors C_{dc1} and C_{dc2} have capacitance values equal to each other with their respective shared voltages being E_{d}/2.

Between the connection point of the switching devices Q₁ and Q₂ and the connection point of the capacitors C_{dc1} and C_{dc2}, a capacitor Cᵣ, an inductor Lᵣ and the primary winding N₁ of the transformer Tr are connected in series. Both ends of the secondary winding N₂ of the transformer Tr are connected to the rectifier circuit REC. Here, the capacitor Cᵣ and inductor Lᵣ form an LC resonant circuit.

For the inductor Lᵣ, the leakage inductance of the primary winding N₁ of the transformer Tr can be utilized.

The rectifier circuit REC is provided with a bridge circuit formed of diodes D₃ to D₆ and a smoothing capacitor Cₒ connected between the DC output terminals of the bridge circuit. The AC input side of the bridge circuit is connected to both ends of the secondary winding N₂ and, across the smoothing capacitor Cₒ, a load R is connected.

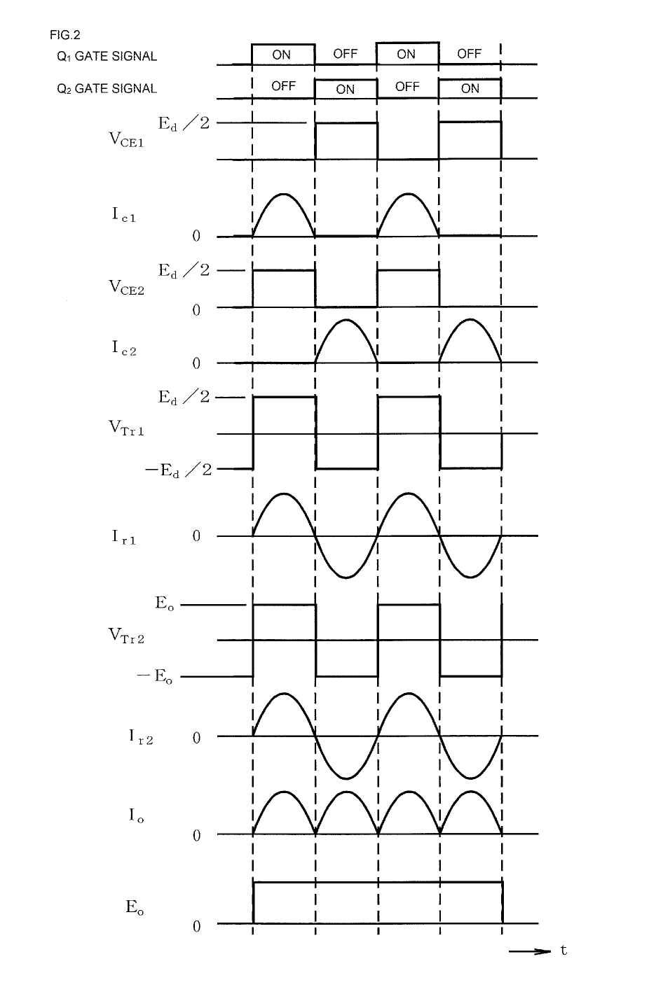

In the next, the operation of the embodiment will be explained with reference to FIG. 2 as a waveform diagram showing the operation of the main circuit of the electric power converter according to the embodiment of the disclosure shown in FIG. 1. The positive directions of the currents and voltages shown in FIG. 2 are determined as the directions of arrows attached to the signs of the corresponding currents and voltages shown in FIG. 1.

First, the switching devices Q₁ and Q₂ forming the inverter INV are alternately switched with a duty ratio of 50% as is shown in FIG. 2 by the resonant frequency of the LC resonant circuit formed of the capacitor Cᵣ and the inductor Lᵣ.

This provides the waveforms as are shown in FIG. 2 for the current I_{c1} and voltage V_{CE1} of the switching device Q₁ and the current I_{c2} and the voltage V_{CE2} of the switching device Q₂, by which a rectangular-wave-like voltage V_{Tr1} is applied to the primary winding N₁ of the transformer Tr to make a sinusoidal-wave-like current Iᵣ₁ flow therein. The waveforms of the voltage V_{Tr1} and current Iᵣ₁ are in phase with the waveforms of the currents I_{c1} and I_{c2} and the voltages V_{CE1} and V_{CE2} as the fundamental waves.

In more detail, when the voltage V_{CE1} becomes 0V by the turning-on of the switching device Q₁ to allow the voltage E_{d}/2 across the capacitor C_{dc1} to be applied to the LC resonant circuit, the current I_{c1} flows by the applied voltage E_{d}/2 through the path of the capacitor C_{dc1}→the switching device Q₁→the capacitor Cᵣ→the inductor Lᵣ→the primary winding N₁ of the transformer Tr→the capacitor C_{dc1}.

In addition, when the voltage V_{CE2} becomes 0V by the turning-on of the switching device Q₂ to allow the voltage E_{d}/2 across the capacitor C_{dc2} to be applied to the LC resonant circuit, the current I_{c2} flows by the applied voltage E_{d}/2 through the path of the capacitor C_{dc2}→the primary winding N₁ of the transformer Tr→the inductor Lᵣ→the capacitor Cᵣ→the switching device Q₂→the capacitor C_{dc2}.

Thus, the current Iᵣ₁ flowing in the primary winding N₁ of the transformer Tr becomes a current which is provided as a combination of the currents I_{c1} and I_{c2} (their respective current values are also designated as I_{c1} and I_{c2}) to have a value I_{C1}-I_{C2} as is shown in FIG. 2.

Moreover, the voltage V_{Tr2} and current Iᵣ₂ of the secondary winding N₂ of the transformer Tr become in phase with the voltage V_{Tr1} and current Iᵣ₁ of the primary winding N₁, respectively. The current Iᵣ₂ is subjected to full-wave rectification in the rectifier circuit REC to be a DC output current Iₒ. Then, the DC output current Iₒ is supplied to a load R, from both ends of which a DC output voltage Eₒ, which is smoothed by the smoothing capacitor Cₒ, is outputted with a specified magnitude.

By the foregoing operation, zero-current switching can be carried out at the timings of turning-on and -off the switching devices Q₁ and Q₂. In addition, the use of devices made of wide bandgap semiconductor material for the switching devices Q₁ and Q₂ allows the devices to reduce switching losses, to be operated at high-speeds and to have high breakdown voltages.

Further, at the turning-on of the switching devices Q₁ and Q₂, their respective freewheeling diodes D₁ and D₂ have no reverse recovery currents flowing therein. Thus, even in the case of using inexpensive devices made of silicon-based semiconductor material for the freewheeling diodes D₁ and D₂, there is no possibility of causing losses.

Therefore, switching losses in the devices can be ideally made to be approximately zero.

Although not shown in FIG. 1, a step-up chopper provided with a switching devices made of wide bandgap semiconductor material and a freewheeling diode made of silicon-based semiconductor material may be inserted as necessary between the DC power supply E_{d} and the series circuit of the capacitors C_{dc1} and C_{dc2} to raise the DC power supply voltage supplied from the DC power supply E_{d} and apply the raised DC voltage across the series circuit of the switching devices Q₁ and Q₂.

The electric power converter according to the disclosure can be utilized for various kinds of electric power converters and power supplies on which downsizing is strongly required like on auxiliary power supplies for rolling stock.

Inclusion in this disclosure of any characterization of any product or method of the related art does not imply or admit that such characterization was known in the prior art or that such characterization would have been appreciated by one of ordinary skill in the art at the time a claimed was made, even if the product or method itself was known in the prior art at the time of invention of the present disclosure. For example, if a related art document discussed in the foregoing sections of this disclosure constitutes prior art, the inclusion of any characterization of the related art document does not imply or admit that such characterization of the related art document was known in the prior art or would have been appreciated by one of ordinary skill in the art at the time a claimed was made, especially if the characterization is not disclosed in the related art document itself.

While the present disclosure has been particularly shown and described with reference to embodiment thereof, such as those discussed above, it will be understood by those skilled in the art that the foregoing and other changes in form and details can be made therein without departing from the spirit and scope of the present invention.

What is claimed is:

1. An electric power converter comprising:
an inverter configured to convert an input DC voltage, supplied from a DC power supply, to an AC voltage outputted at an AC output side of the inverter, the inverter comprising
at least one semiconductor switching device made of wide bandgap semiconductor material, configured to be connected to the DC power supply, and configured to carry out turning-on and turning-off operations at a specified frequency to thereby invert the DC voltage to the AC voltage at the specified frequency; and
at least one freewheeling diode made of silicon-based semiconductor material respectively connected to the at least one semiconductor switching device in inverse parallel;
an insulating transformer having a primary winding connected to the AC output side of the inverter, and having a secondary winding; and
a rectifier configured to convert AC voltage outputted from the secondary winding of the transformer to a DC voltage to supply the converted DC voltage to a load.

2. The electric power converter according to claim 1, wherein
the at least one semiconductor switching device comprises a plurality of semiconductor switching devices configured to switch on and off alternately.

3. The electric power converter according to claim 1, wherein
the at least one semiconductor switching device includes a first semiconductor switching device and a second semiconductor switching device connected in series as a first series circuit and configured to be connected across the DC power supply, and
the inverter further includes
a first capacitor and a second capacitor connected to each other in series to form a second circuit that is connected in parallel to the first series circuit formed by the semiconductor switching devices
a resonant circuit, including a series connection of a capacitor and an inductor, to carry out a resonant operation at a resonant frequency, and
the resonant circuit and the primary winding of the transformer are connected in series between a connection point connecting between the first and second semiconductor switching devices and a connection point connecting between the first and second capacitors, and
the electric power converter is configured to turn the first and second semiconductor switching devices on and off alternately with a duty ratio of 50% by the resonant frequency of the resonant circuit.

4. The electric power converter according to claim 1, wherein the at least one semiconductor switching device is a field effect transistor (FET) made of one of SiC, GaN and diamond as the wide bandgap semiconductor material.

5. The electric power converter according to claim 2, wherein the at least one semiconductor switching device is a field effect transistor (FET) made of one of SiC, GaN and diamond as the wide bandgap semiconductor material.

6. The electric power converter according to claim 3, wherein the at least one semiconductor switching device is a field effect transistor (FET) made of one of SiC, GaN and diamond as the wide bandgap semiconductor material.
